(19) United States
(12) Patent Application Publication
(10) Pub. No.: US 2026/0296533 A1
(43) Pub. Date: Oct. 1, 2026

(54) STEER-BY-WIRE STEERING SYSTEM

(71) Applicant: HONDA MOTOR CO., LTD., Tokyo (JP)

(72) Inventors: Masaya KUSATANI, Tokyo (JP); Keisuke KUMAGAI, Tokyo (JP); Ryota MOSE, Tokyo (JP)

(21) Appl. No.: 19/577,853

(22) Filed: Mar. 25, 2026

(30) Foreign Application Priority Data
Mar. 31, 2025 (JP) 2025-059144

(51) Int. Cl. B62D 5/04

(52) U.S. Cl. CPC B62D 5/049; B62D 5/046

(57) ABSTRACT

A steer-by-wire steering system includes two rack position sensors each configured to detect the position of a rack to operate a road wheel angle of a steered wheel, two road wheel actuators (RWAs) each configured to operate the rack based on an output of the corresponding rack position sensor, and a single hand wheel actuator (HWA) electrically coupled to the RWAs and configured to apply an operation reaction force to a steering wheel configured to steer a vehicle. An output signal of one of the rack position sensors is inputted to the corresponding one of the RWAs via the HWA. An output signal of the other rack position sensor is directly inputted to the other RWA.

### BACKGROUND OF THE INVENTION

### 1. Field of The Invention

The present invention relates to a steer-by-wire steering system that steers steered wheels while a steering wheel is mechanically separated from the steered wheels.

### 2. Description of the Related Art

Heretofore, the steer-by-wire steering system has been designed with redundancy in case of a malfunction or the like of a component in the system.

For example, a steer-by-wire steering system disclosed in US2023/0406408A has a configuration with redundancy secured by including two sub-systems for each of a steering wheel side (a steering angle sensor (SAS) and a hand wheel actuator (HWA)) and a road wheel side (a road wheel actuator (RWA) and a rack position sensor (RPS)).

However, the configuration of the steering system proposed by US2023/0406408A secures the redundancy by including the two sub-systems for each of the steering wheel side and the road wheel side, which has the problem of leading to the larger size, heavier weight, and higher cost of the entire system.

### SUMMARY OF THE INVENTION

The present invention has been made in consideration of the above point, and has an object to provide a steer-by-wire steering system that enables more effective use of a limited interior space in a vehicle by reducing the size, weight, and cost of the entire system while securing redundancy.

The present invention also enables the use of the widened free space to improve the safety, which will in turn further improve traffic safety and contribute to the development of a sustainable transportation system.

In order to the above object, a steer-by-wire steering system according to the present invention includes two rack position sensors each configured to detect a position of a rack configured to operate a road wheel angle of a steered wheel; two road wheel actuators (RWAs) each configured to operate the rack based on an output signal of the corresponding one of the rack position sensors; and a hand wheel actuator (HWA) electrically coupled to the RWAs and configured to apply an operation reaction force to a steering wheel configured to steer a vehicle. An output signal of one of the rack position sensors is inputted to the corresponding one of the RWAs via the HWA, and an output signal of the other rack position sensor is directly inputted to the other RWA.

The present invention is intended to provide a steer-by-wire steering system that enables more effective use of a limited interior space in a vehicle by reducing the size, weight, and cost of the entire system while securing redundancy.

The present invention enables the use of the widened free space to improve the safety, which will in turn further improve traffic safety and contribute to the development of a sustainable transportation system.

### BRIEF DESCRIPTION OF THE DRAWINGS

FIG. 1 is a configuration diagram of a steer-by-wire steering system in a present embodiment under normal conditions.

FIG. 2 is a block diagram showing how a first sub-system in the steer-by-wire steering system in the present embodiment works under the normal conditions.

FIG. 3 is a block diagram showing how a second sub-system in the steer-by-wire steering system in the present embodiment works under the normal conditions.

FIG. 4 is a configuration diagram of the steer-by-wire steering system in the present embodiment under malfunction conditions.

FIG. 5 is a block diagram showing how the first sub-system in the steer-by-wire steering system in the present embodiment works under the malfunction conditions.

FIG. 6 is a block diagram showing how the second sub-system in the steer-by-wire steering system in the present embodiment works under the malfunction conditions.

### DETAILED DESCRIPTION OF THE EMBODIMENTS

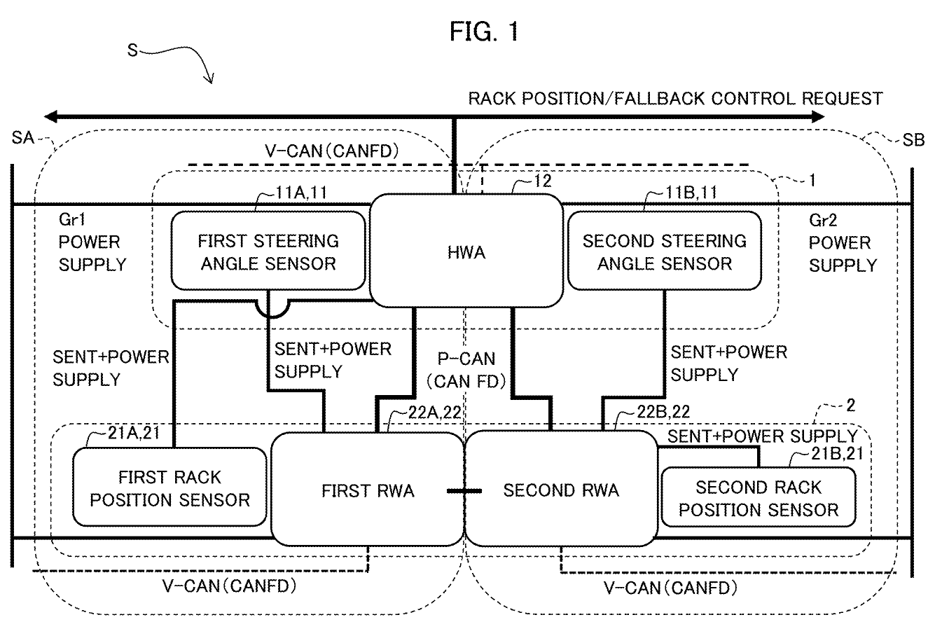

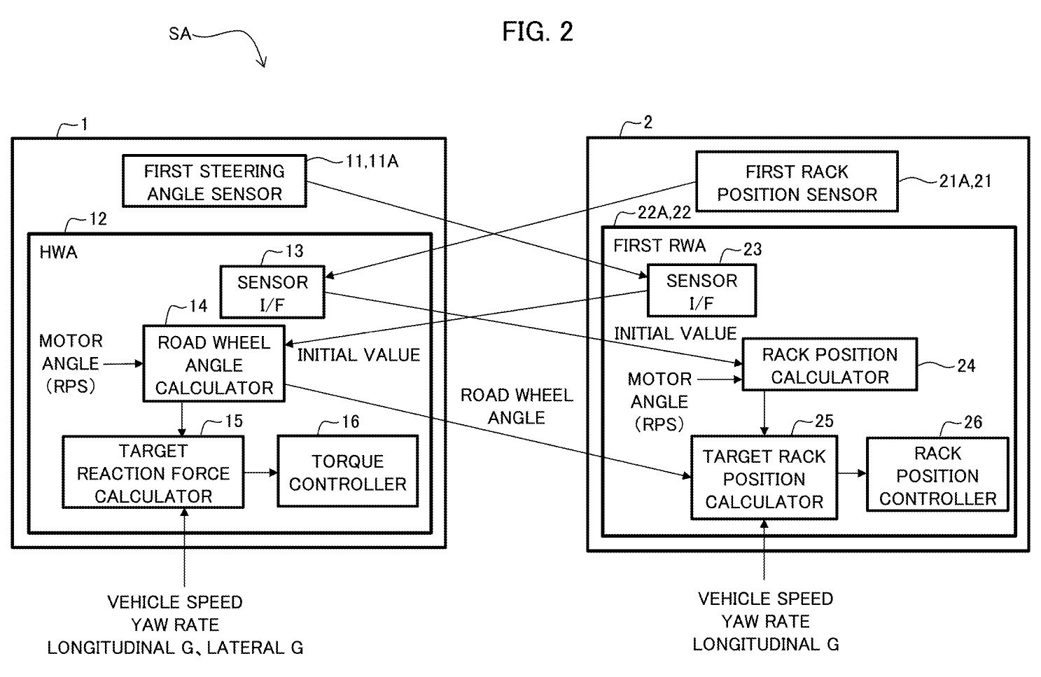

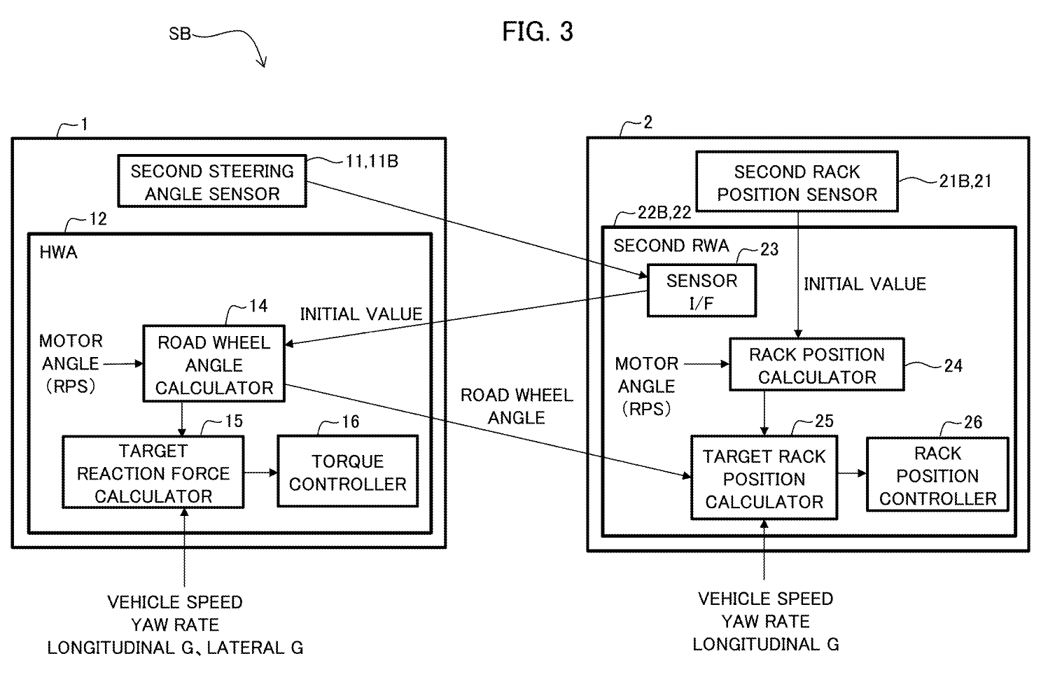

A steer-by-wire steering system S (hereinafter referred to as the steering system) in an embodiment of the present invention will be described in detail with reference to FIGS. 1-6.

In the description, the same elements will be assigned with the same reference signs, and the repetitive description thereof will be omitted.

The steering system S in the present embodiment is installed on a vehicle (not shown) in which front wheels (not shown) are set as steered wheels (see FIGS. 1-3).

The steering system S steers the front wheels in a state where a steering wheel (not shown) operated by a driver is mechanically separated from the front wheels.

The steering system S includes a steering wheel-side mechanism 1 and a road wheel-side mechanism 2.

Since the steering system S in the present embodiment is of a steer-by-wire type, the steering wheel-side mechanism 1 and the road wheel-side mechanism 2 are mechanically separated from each other, but are electrically coupled to each other.

The steering wheel-side mechanism 1 is configured to calculate and determine a road wheel angle of the front wheels according to a steering angle of the steering wheel operated by the driver (see FIGS. 1-3).

The steering wheel-side mechanism 1 includes a steering angle sensor 11 and a hand wheel actuator 12 (hereinafter abbreviated as HWA).

The steering angle sensor 11 detects an angle at which the steering wheel is operated (steering angle) and outputs it as an electric signal (steering angle signal).

The HWA 12 calculates an angle at which the front wheels are to be steered (road wheel angle) from the steering angle signal inputted via a road wheel actuator 22 (hereinafter abbreviated as RWA) to be described later, and outputs it as an electric signal (road wheel angle command signal) to the RWA 22 to be described later.

The HWA 12 also calculates an operation reaction force that simulates a steering reaction force in steering from the calculated road wheel angle, and applies the calculated operation reaction force to the steering wheel.

Here, the single HWA 12 is installed in the steering system S.

The HWA 12 includes a sensor interface (IF) 13, a road wheel angle calculator 14, a target reaction force calculator 15, and a torque controller 16.

The sensor IF 13 is a unit to receive an output signal (rack position signal) of a rack position sensor 21 to be described later, and transmit the received rack position signal to the RWA 22.

The road wheel angle calculator 14 is a unit to calculate the road wheel angle from the steering angle signal of the steering angle sensor 11.

The target reaction force calculator 15 is a unit to calculate the operation reaction force from the calculated road wheel angle.

The torque controller 16 is a unit to apply the calculated operation reaction force to the steering wheel.

The road wheel-side mechanism 2 includes a rack (not shown), the rack position sensor 21, and the RWA 22 (see FIGS. 1-3).

The rack is mechanically linked to the front wheels, and the front wheels are steered with an operation performed on the rack.

The rack position sensor 21 detects a position of the rack in the vehicle width direction (hereinafter referred to as "rack position") and outputs it as an electric signal (rack position signal) to the RWA 22 .

The RWA 22 calculates a rack movement amount, a rack movement speed, and a road wheel angle of the front wheels based on the rack position signal and the road wheel angle command signal, and controls the rack based on the calculation results.

The RWA 22 includes a sensor IF 23, a rack position calculator 24, a target rack position calculator 25, and a rack position controller 26.

The sensor IF 23 is a unit to receive the steering angle signal outputted from the steering angle sensor 11, and to transmit the received steering angle signal to the HWA 12.

The rack position calculator 24 is a unit to calculate the current rack position (before steering) from the rack position signal outputted from the rack position sensor 21.

The target rack position calculator 25 is a unit to calculate the rack movement amount and a post-movement rack position from the road wheel angle calculated by the road wheel angle calculator 14.

The rack position controller 26 is a unit to steer the front wheels by moving the rack to a predetermined position based on the calculated current rack position and rack movement amount.

In the present steering system S, two steering angle sensors 11, two rack position sensors 21, and two RWAs 22 are installed to secure redundancy (see FIGS. 1 to 3).

Therefore, the description of the two steering angle sensors 11 will be continued with one of the steering angle sensors 11 referred to as a first steering angle sensor 11Aand the other steering angle sensor 11 referred to as a second steering angle sensor 11B.

Then, the description of the two rack position sensors 21 will be continued with one of the rack position sensors 21 referred to as a first rack position sensor 21A and the other rack position sensor 21 referred to as a second rack position sensor 21B.

Moreover, the description of the two RWAs 22 will be continued with one of the RWAs 22 referred to as a first RWA 22A and the other RWA 22 referred to as a second RWA 22B.

The first RWA 22Aand the second RWA 22B are electrically coupled to each other. When both of the first RWA 22A and the second RWA 22Bare normally functioning, any one of them (for example, the first RWA 22A) is preferentially used to operate the rack.

Then, a sub-system including the first steering angle sensor 11A, the first rack position sensor 21A, the first RWA 22A, and the HWA 12 will be referred to as a first sub-system SA.

Meanwhile, a sub-system including the second steering angle sensor 11B, the second rack position sensor 21B, the second RWA 22B, and the HWA 12 will be referred to as a second sub-system SB.

It should be noted that the HWA 12 is shared by the first sub-system SA and the second sub-system SB.

The HWA 12 is coupled to each of the first RWA 22A and the second RWA 22B via a communication scheme such as a controlled area network (CAN) or CAN with flexible data rate (CAN FD).

The first steering angle sensor 11A is coupled to the first RWA 22A via a communication scheme such as single edge nibble transmission (SENT), and the second steering angle sensor 11B is coupled to the second RWA 22B via a communication scheme such as SENT.

The steering angle signal of the first steering angle sensor 11A is inputted to the HWA 12 via the sensor IF 23 of the first RWA 22A and the steering angle signal of the second steering angle sensor 11B is inputted to the HWA 12 via the sensor IF 23 of the second RWA 22B.

The first steering angle sensor 11A is supplied with power from the first RWA 22A, and the second steering angle sensor 11B is supplied with power from the second RWA 22B.

The first rack position sensor 21A is coupled to the HWA 12 via a communication scheme such as SENT, and the second rack position sensor 21B is coupled to the second RWA 22B via a communication scheme such as SENT.

The rack position signal of the first rack position sensor 21A is inputted to the first RWA 22A via the sensor IF 13 of the HWA 12.

The first rack position sensor 21A is supplied with power from the HWA 12.

In contrast to this, the rack position signal of the second rack position sensor 21B is inputted to the second RWA 22B.

The second rack position sensor 21B is supplied with power from the second RWA 22B.

Next, how the steering system S works in the present embodiment will be described.

First, how the steering system S works under normal conditions having no malfunction will be described (see FIGS. 1-3).

The steering angle signals of the steering angle sensors 11 are inputted to the HWA 12 via their respective RWAs 22.

In the HWA 12, the road wheel angle calculator 14 calculates the road wheel angle based on each of the steering angle signals and vehicle information (on a vehicle speed and so on) inputted via a communication scheme such as CAN.

Then, the HWA 12 outputs the calculated road wheel angle to each of the RWAs 22.

Moreover, in the HWA 12, the target reaction force calculator 15 calculates a target reaction force based on the calculated road wheel angle and the vehicle information, and the torque controller 16 applies the operation reaction force to the steering wheel.

The position signal of the first rack position sensor 21A is inputted to the first RWA 22A via the HWA 12.

The position signal of the second rack position sensor 21B is directly inputted to the second RWA 22B.

Each of the RWAs 22 calculates the current rack position (before steering) (initial position) from the position signal.

Each of the RWAs 22 also calculates the target rack position from the road wheel angle received from the HWA 12.

The RWA 22 moves the rack according to the target rack position and the rack thus moved steers the front wheels.

Here, when the first sub-system and the second sub-system are both normally functioning, both of the sub-systems calculate the rack position and the target rack position, and then the calculation results of any one of them (for example, the first sub-system) are preferentially used to move the rack and apply the operation reaction force to the steering wheel.

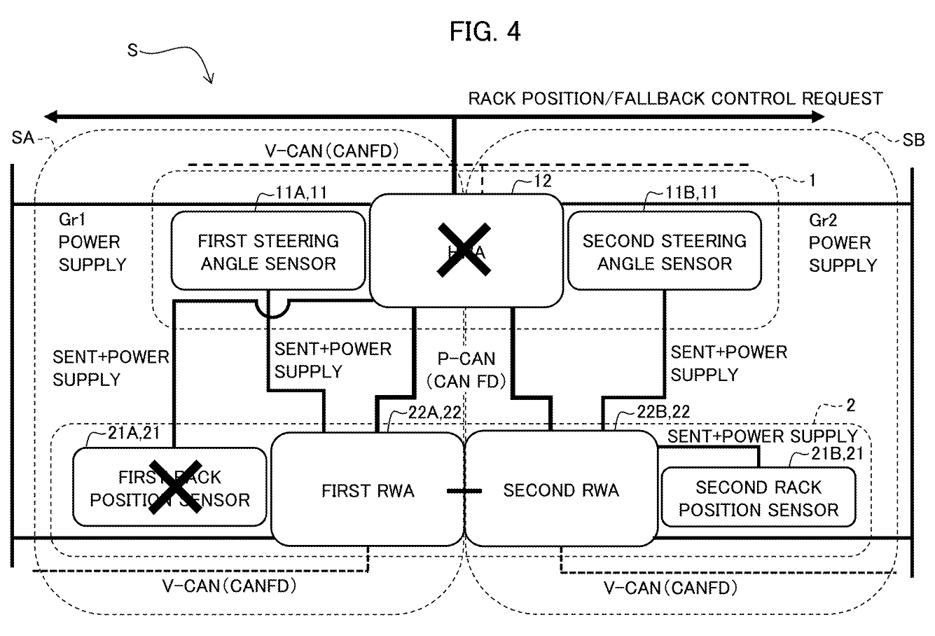

Next, how the steering system S wors in a case where each component in the steering system S malfunctions will be described(see FIGS. 4-6).

The two steering angle sensors 11, the two rack position sensors 21, and the two RWAs 22 are installed. For this reason, even if one of the above two sensors or actuators malfunctions, the other will continue to operate and any functional problem will not occur.

Next, a case where the HWA 12 malfunctions will be described.

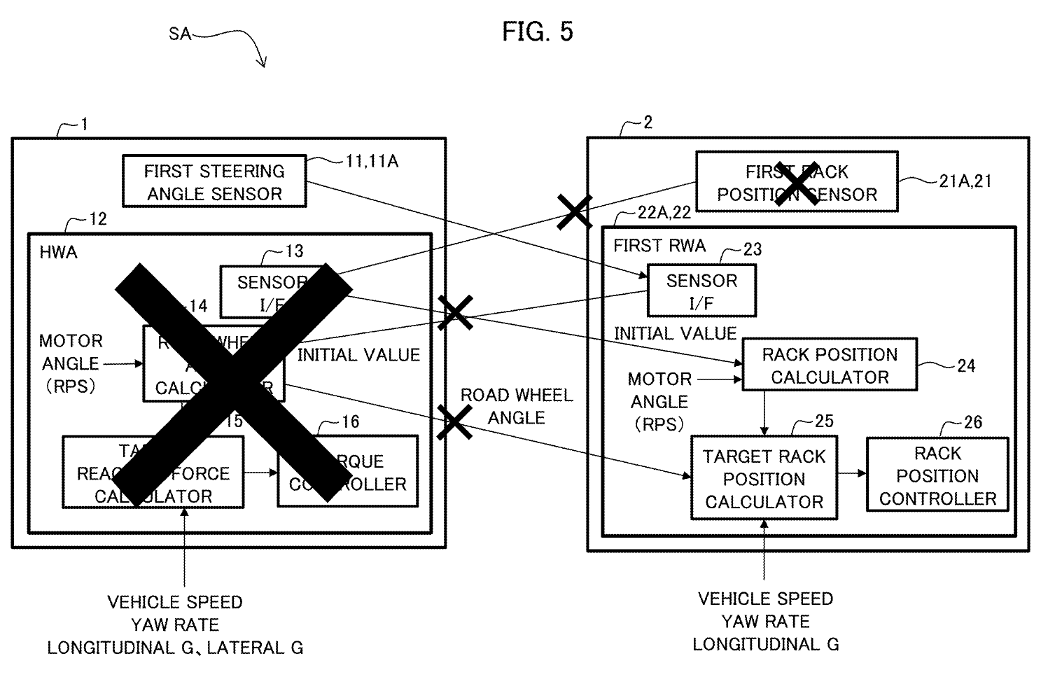

In the first sub-system SA , when the HWA 12 malfunctions, the first rack position sensor 21A is not supplied with power and cannot detect the rack position, which results in the end of the operation (see FIG. 5).

Although the steering angle signal of the first steering angle sensor 11Ais inputted to the HWA 12 via the first RWA 22A, the HWA 12 cannot calculate the road wheel angle and the target reaction force due to the malfunction, which results in the end of the operation.

In other words, when the HWA 12 malfunctions, the first sub-system SA stops functioning.

However, when the HWA 12 enters a malfunction after the ignition is turned on (IG/ON), the control is continued because the rack position is calculated based on a motor position sensor (not shown) in the RWA 22.

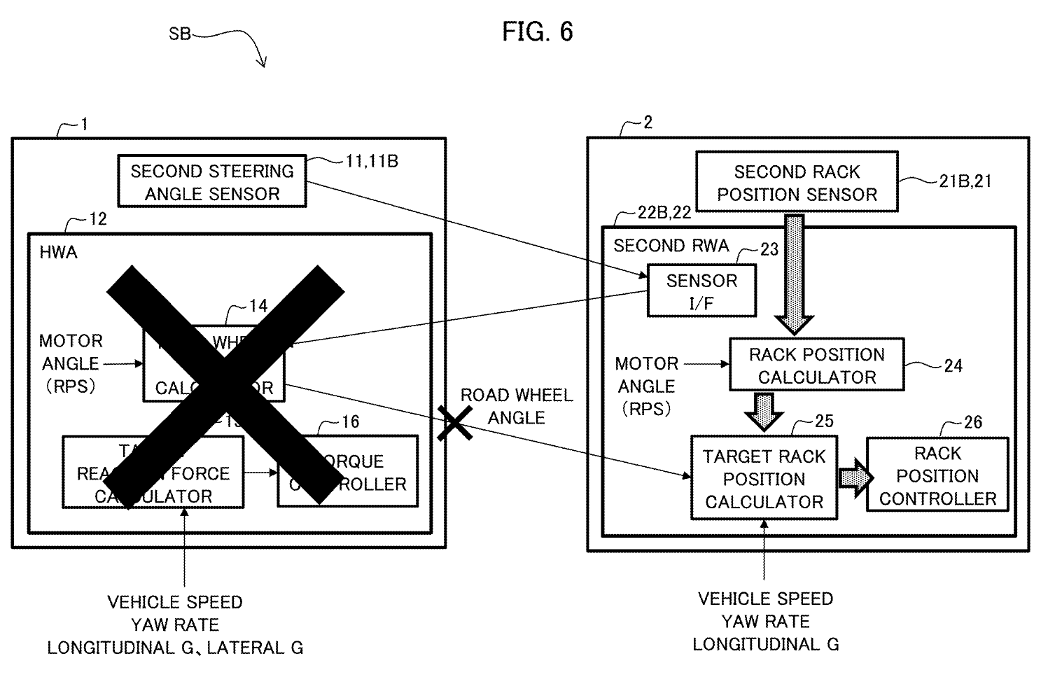

In the second sub-system SB, even when the HWA 12 malfunctions, the position signal of the second rack position sensor 21B is directly inputted to the second RWA 22B (see FIG. 6).

The second RWA 22B calculates the current rack position (before steering) (initial position) from the position signal.

The steering angle signal of the second steering angle sensor 11B is inputted to the second RWA 22B.

Then, the second RWA 22B calculates the road wheel angle based on the steering angle signal of the second steering angle sensor 11B and the vehicle information (on the vehicle speed and so on) inputted via a communication scheme such as CAN.

Next, the second RWA 22B moves the rack according to the target rack position and the rack thus moved steers the front wheels.

Here, the operation reaction force in steering is not applied to the steering wheel because the HWA 12 is malfunctioning.

Next, effects of the present embodiment will be described.

The steer-by-wire steering system S in the present embodiment has the configuration including two steering angle sensors 11, two rack position sensors 21, two RWAs 22, and one HWA 12.

This configuration archives a reduction in the cost of the entire system while securing the system redundancy.

Furthermore, the coupling of the output signal of the second rack position sensor 21B to the second RWA 22B makes it possible to shorten the wiring for the coupling and secure the redundancy for determining the rack position.

In the steer-by-wire steering system S in the present embodiment, the wiring is routed so that the output signal of the first steering angle sensor 11A is inputted to the HWA 12 via the first RWA 22A.

Meanwhile, the wiring is routed so that the output signal of the second steering angle sensor 11B is inputted to the HWA 12 via the second RWA 22B.

In sum, the output signals of the two steering angle sensors 11 are inputted to the HWA 12 via the respectively different RWAs 22.

Even if the HWA 12 or any one of the RWAs 22 malfunctions, this configuration enables the output signal of the steering angle sensor 11 to be inputted to the RWA 22.

Thus, it is possible to continue the function and secure the redundancy.

Moreover, since the first rack position sensor 21A is coupled to the HWA 12, the rack position can be transmitted to an external function on the vehicle side even if the RWAs 22 both malfunction.

Thus, the road wheel angle can be known and the vehicle motion control can be continued.

In the steer-by-wire steering system S in the present embodiment, the first steering angle sensor 11A is supplied with power from the first RWA 22A and the second steering angle sensor 11B is supplied with power from the second RWA 22B.

In addition, in the steer-by-wire steering system S in the present embodiment, the first rack position sensor 21A is supplied with power from the HWA 12 and the second rack position sensor 21B is supplied with power from the second RWA 22B.

This configuration makes it possible to route power supply lines to these sensors along their respective output signal lines.

This simplifies the configuration of a wire harness and makes the wiring work easy, which may prevent incorrect wiring.

What is claimed is:

1. A steer-by-wire steering system comprising:
two rack position sensors each configured to detect a position of a rack configured to operate a road wheel angle of a steered wheel;
two road wheel actuators (RWAs) each configured to operate the rack based on an output signal of the corresponding one of the rack position sensors; and
a single hand wheel actuator (HWA) electrically coupled to the RWAs and configured to apply an operation reaction force to a steering wheel configured to steer a vehicle, wherein
an output signal of one of the rack position sensors is inputted to the corresponding one of the RWAs via the HWA, and
an output signal of the other rack position sensor is directly inputted to the other RWA.

2. The steer-by-wire steering system according to claim 1, comprising two steering angle sensors each configured to detect a steering angle of the steering wheel, wherein
an output signal of one of the steering angle sensors is inputted to the HWA via the corresponding one of the RWAs, and
an output signal of the other steering angle sensor is inputted to the HWA via the other RWA.
